(19) United States
(12) Patent Application Publication
(10) Pub. No.: US 2026/0365024 A1
(43) Pub. Date: Nov. 19, 2026

(54) Moveable Dual Plane Heater

(71) Applicant: Illinois Tool Works Inc., Glenview, IL (US)

(72) Inventors: Edward Mehall, Geneva, IL (US); Jeanne Baspeyras, Chambly (FR); Fredrik Andersson, Vasteras (SE); Christian Engel, Ahlden (DE); Zsolt Wilke, Bad Mergentheim (DE); Salvatore Cicero, Oberthulba-Witterhausen (DE)

(21) Appl. No.: 19/671,621

(22) Filed: May 8, 2026

Related U.S. Application Data
(60) Provisional application No. 63/805,438, filed on May 14, 2025.
(60) Provisional application No. 63/854,698, filed on Jul. 31, 2025.

(51) Int. Cl. B60K 35/40; F03G 7/06

(52) U.S. Cl. CPC B60K 35/415; F03G 7/0614; B60K 2360/785

(57) ABSTRACT

A vehicle sensor system includes a sensor payload configured to detect an external environment and a housing assembly supporting the sensor payload adjacent a transparent vehicle surface (such as a windshield). A glare shield is disposed between the sensor payload and the transparent vehicle surface and defines at least a portion of a sensor cavity. The glare shield includes a first panel and a second panel arranged in a dual-plane configuration to attenuate light entering the sensor payload from outside a field of view. At least one of the first panel or the second panel includes a heater having one or more resistive elements configured to generate heat within the sensor cavity. At least one of the first panel or the second panel is movable relative to the sensor payload to adjust a geometry of the sensor cavity and an optical path between the sensor payload and the transparent vehicle surface.

### RELATED APPLICATIONS

The present application claims priority to U.S. Provisional Patent Application No. 63/805,438, filed May 14, 2025, and U.S. Provisional Patent Application No. 63/854,698, filed Jul. 31, 2025, each entitled “Movable Dual Plane Heater,” which are hereby incorporated by reference.

### BACKGROUND

Vehicular safety systems are increasingly being developed to assist drivers in maintaining vehicle control and awareness. One such system, commonly referred to as a lane departure warning (LDW) system, is configured to determine whether a vehicle is being maintained within a designated lane on a roadway and, if not, to provide a warning to the driver.

LDW systems may employ one or more sensors, such as cameras, mounted within the vehicle compartment. In many examples, the camera is positioned between the center rearview mirror and the windshield so that its field of view encompasses the roadway ahead of the vehicle. A glare shield may be positioned between the camera and the windshield to reduce stray or high-intensity light, originating outside the camera's intended field of view, from degrading image acquisition.

Other types of sensors are also being developed for use in advanced driver-assistance systems (ADAS) capable of detecting pedestrians, other vehicles, and obstacles in the vehicle's vicinity. Such sensors enable the vehicle to automatically control its acceleration and braking to maintain appropriate spacing relative to surrounding objects. Continued advancements in these technologies are expected to support semi-autonomous and fully autonomous vehicle operation.

Sensors used for these purposes may include, for example, radar, LIDAR, infrared imaging, visible-light imaging, or ultrasonic sensors. The performance of these sensors can be adversely affected by environmental and optical conditions, including glare from sunlight, headlights, or reflective surfaces, which can saturate detectors, reduce contrast, and impair signal interpretation. The use of protective shields or covers in front of the sensor may also introduce reflections or secondary glare paths that interfere with operation. In particular, radar sensors may be affected by conductive materials, such as metallic heating elements, positioned over the sensor, as these materials can attenuate or block radio wave propagation.

Cameras used for LDW systems rely on clear, high-contrast image signals to detect lane markings and determine the vehicle's position relative to those markings. Image quality can deteriorate when glare from external light sources enters the optical path, such as low-angle sunlight, oncoming headlights, or wet-road reflections. Internal reflections within the windshield, glare shield, or sensor housing may further exacerbate these effects, leading to reduced visibility of lane markings and increased processing uncertainty. While certain approaches attempt to reduce these effects through shielding or coatings, such solutions may add complexity, cost, or impose design constraints.

Accordingly, there remains a need for systems and methods that mitigate or control glare affecting vehicle-mounted sensors, such as those used in LDW and related ADAS applications.

### SUMMARY

The present disclosure relates generally to a demisting sensor system, substantially as illustrated by and described in connection with at least one of the figures, as set forth more completely in the claims. In an example, the present disclosure relates to a movable dual plane heater.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A illustrates a vehicle equipped with one or more sensor systems.

FIG. 1B illustrates an assembled cross-sectional perspective view of an example sensor system, taken along cut line A-A of FIG. 1A.

FIG. 2 illustrates an assembled cross-sectional side elevation view of a sensor system, in accordance with one aspect of the subject disclosure, taken along cut line A-A of FIG. 1A.

FIG. 3a illustrates an assembled cross-sectional side elevation view of a sensor system taken along cut line A-A of FIG. 1A, where the glare shield is configured in a first position during daytime (e.g., sunlight).

FIG. 3b illustrates an assembled cross-sectional side elevation view of a sensor system taken along cut line A-A of FIG. 1A, where the glare shield is configured in the first position during nighttime (e.g., oncoming headlights).

FIG. 4a illustrates an assembled cross-sectional side elevation view of a sensor system taken along cut line A-A of FIG. 1A, where the glare shield is configured in the first position to be more effective for daytime conditions.

FIG. 4b illustrates an assembled cross-sectional side elevation view of a sensor system taken along cut line A-A of FIG. 1A, where the glare shield is configured in a second position to be more effective for nighttime conditions.

FIGS. 5a and 5b illustrate assembled cross-sectional side elevation views of a sensor system with a movable glare shield that is configured to alternate between, respectively, the first position and the second position in accordance with one aspect of the subject disclosure.

FIGS. 6a and 6b illustrate assembled cross-sectional side elevation views of a sensor system with a movable glare shield that is configured to alternate between, respectively, the first position and the second position in accordance with another aspect of the subject disclosure.

FIGS. 7a and 7b illustrate assembled cross-sectional side elevation views of a sensor system with a movable glare shield that is configured to alternate between the first position and the second position in accordance with another aspect of the subject disclosure.

FIGS. 8a and 8b illustrate assembled cross-sectional side elevation views of a sensor system with a movable glare shield that is configured to alternate between, respectively, a sealed position and a vented position in accordance with one aspect of the subject disclosure.

FIGS. 9a through 9c illustrate assembled cross-sectional side elevation views of a sensor system with a movable glare shield that is configured to alternate between the sealed position and the vented position in accordance with one aspect of the subject disclosure.

FIGS. 10a and 10b illustrate assembled cross-sectional side elevation views of a sensor system with a movable glare shield that is configured to alternate between the sealed position and the vented position in accordance with another aspect of the subject disclosure.

FIGS. 11a and 11b illustrate assembled cross-sectional side elevation views of a sensor system with a movable glare shield that is configured to alternate between the sealed position and the vented position in accordance with yet another aspect of the subject disclosure.

FIGS. 12a and 12b illustrate assembled cross-sectional side elevation views of a sensor system with a movable glare shield that is configured to alternate between the sealed position and the vented position in accordance with a further aspect of the subject disclosure.

FIGS. 13a and 13b illustrate assembled cross-sectional side elevation views of a sensor system with a movable glare shield that is configured to alternate between the sealed position and the vented position in accordance with a further aspect of the subject disclosure.

FIGS. 14a and 14b illustrate assembled cross-sectional side elevation views of a sensor system with a movable glare shield that is configured to alternate between the sealed position and the vented position in accordance with a further aspect of the subject disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a sensor system for use with a component of a vehicle, such as a windshield. The vehicle sensor system includes a sensor payload configured to detect an external environment and a housing assembly supporting the sensor payload adjacent to a transparent vehicle surface. A glare shield is disposed between the sensor payload and the transparent vehicle surface and defines at least a portion of a sensor cavity. The glare shield includes a first panel and a second panel arranged in a dual-plane configuration to attenuate light entering the sensor payload from outside a field of view. At least one of the first panel or the second panel includes a heater having one or more resistive elements configured to generate heat within the sensor cavity. At least one of the first panel or the second panel is movable relative to the sensor payload to adjust a geometry of the sensor cavity and an optical path between the sensor payload and the transparent vehicle surface.

In one example a housing assembly for a sensor payload configured to detect an environment through a windshield of a vehicle comprises: a glare shield configured to define a sensor cavity adjacent the windshield, wherein the glare shield comprises a movable portion configured to move between at least a first position and a second position, wherein the movable portion is coupled to an actuator configured to move the movable portion between the first position and the second position, and wherein, based on the position of the movable portion, the movable portion is configured to modify at least one of: (i) light propagation through the windshield into the sensor cavity, or (ii) airflow within the sensor cavity through the glare shield.

In another examples, a system for sensing an environment through a windshield of a vehicle comprises: a sensor payload configured to detect an environment through a windshield of the vehicle; and a housing assembly configured to define a sensor cavity adjacent the windshield, the housing assembly comprising a glare shield and an actuator, wherein the glare shield comprises a movable portion coupled to the actuator and configured to move between at least a first position and a second position, and wherein, based on the position of the movable portion, the movable portion is configured to modify at least one of: (i) light propagation through the windshield into the sensor cavity, or (ii) airflow within the sensor cavity through the glare shield.

In some examples, the first position is configured to reduce glare from light entering from above, and the second position is configured to reduce glare from light entering from a forward direction.

In some examples, the movable portion is pivotally mounted to at least one side portion of the glare shield.

In some examples, the movable portion is actuated by a mechanical linkage coupled to the actuator.

In some examples, the actuator comprises a shape memory alloy (SMA) actuator.

In some examples, the actuator comprises a bimetal actuator configured to deform in response to temperature.

In some examples, the housing assembly further comprises a spring configured to bias the movable portion toward one of the first position or the second position.

In some examples, the spring comprises at least one of a flat spring, a torsion spring, or a compression element.

In some examples, the movable portion includes an end stop configured to define at least one limit position.

In some examples, the movable portion is configured to contact the windshield in one of the positions.

In some examples, the glare shield includes a heater layer configured to heat the sensor cavity.

In some examples, the housing assembly further comprises a ventilation assembly including an airflow port and a valve element coupled to the movable portion.

In some examples, the valve element is configured to selectively open and close the airflow port based on the position of the movable portion.

In some examples, the actuator is a thermally-responsive actuator.

In some examples, the housing assembly further comprises a secondary heater configured to control movement of the movable portion independently of a primary heater.

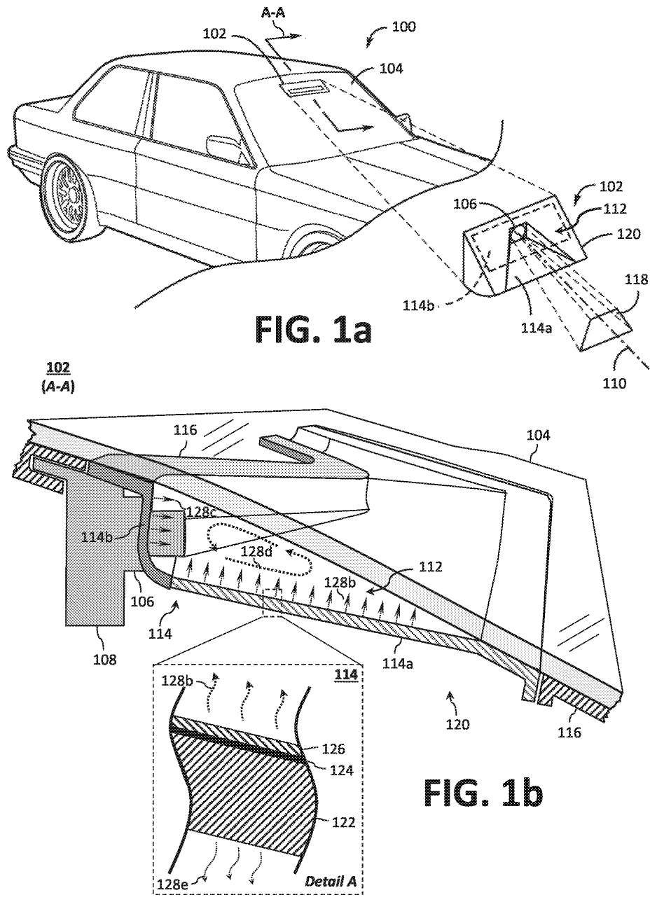

FIG. 1a illustrates a vehicle 100 equipped with one or more sensor systems 102, which may be positioned at various locations on the vehicle 100 to provide environmental sensing, detection, or monitoring functionality. The sensor systems 102 can include, for example, optical, radar, lidar, or ultrasonic sensors, each housed within a housing assembly 120 that provides mechanical support, environmental protection, and integration with vehicle structures. The housing assembly 120 may be configured to maintain the operational stability of the sensors across a wide range of environmental conditions, including extreme temperatures, humidity, and vibration. FIG. 1b illustrates an assembled cross-sectional perspective view of an example sensor system 102, taken along cut line A-A of FIG. 1a. As illustrated, the sensor system 102 includes the housing assembly 120 configured to support and protect various internal optical and electronic components and to incorporate environmental control features for mitigating condensation, frost, and particulate contamination on the optical surfaces of the sensor system 102.

The one or more sensor systems 102 can be positioned in or on various portions of a structural element of the vehicle 100. In the illustrated example, the vehicle 100 includes a windshield 104, and one or more of the sensor systems 102 are mounted to or integrated with the windshield 104. Each sensor system 102 may include a sensor payload 106 configured to monitor one or more aspects of the environment surrounding the vehicle 100, such as detecting obstacles, determining distances, identifying traffic signs, recognizing lane markings, or monitoring ambient lighting conditions. In one example, the sensor system 102 is configured to provide lane departure warning (LDW) functionality and may be positioned proximate a top-center region of the windshield 104. LDW capability, however, represents merely one implementation, and the disclosed sensor system 102 and associated features disclosed herein can be used for a variety of perception or driver-assistance applications.

The sensor payload 106 can be configured to exchange electrical signals with a sensor interface circuit, which can communicate with a vehicular control unit (e.g., an electronic control unit (ECU)) of the vehicle 100. The vehicular control unit may process sensor data to perform various autonomous or semi-autonomous functions such as steering control, braking assistance, adaptive cruise control, and collision avoidance. Additionally, the sensor payload 106 may interface with cockpit display systems to present visual or auditory alerts to vehicle occupants, such as lane departure warnings, obstacle detection indications, or traffic sign recognition cues.

While the subject disclosure is primarily described in connection with a sensor system 102 mounted on an interior side of the windshield 104, the same principles and design considerations can be applied to sensor systems 102 positioned on other exterior or interior vehicle components, such as bumpers, grilles, side mirrors, or roof modules. The sensor payload 106 can include one or more perception sensors configured to detect, classify, and interpret the vehicle's surrounding environment.

The sensor payload 106 may be secured within a sensor housing 108, which is in turn coupled to or integrated with the housing assembly 120. The sensor housing 108 can be composed of a rigid polymer, glass-filled thermoplastic, aluminum alloy, or composite material, providing structural rigidity and thermal stability. The sensor housing 108 may include precision alignment or registration features to position the sensor payload 106 at a desired focal distance and orientation relative to the windshield 104. The sensor housing 108 can further include environmental sealing features (e.g., gaskets, O-rings, or ultrasonic welds) to prevent the ingress of moisture and debris while allowing thermal dissipation from internal electronic components.

The illustrated sensor system 102 positions the sensor payload 106 at least partially within the housing assembly 120, with a view axis 110 oriented forward toward the roadway. The sensor payload 106 is configured to detect features or objects within a field of view 118 extending about the view axis 110. The housing assembly 120 includes a glare shield 114 and a structural bracket 116, among other components. The glare shield 114 defines a sensor cavity 112 that surrounds or partially encloses the sensor payload 106, blocking or attenuating incident light from off-axis or high-angle sources that fall outside the desired field of view 118. This arrangement minimizes optical interference, ghosting, and glare, thereby improving image quality and measurement precision.

With continued reference to FIG. 1b, the glare shield 114 includes a first glare panel 114a (for example, a lower or generally horizontal panel) extending between the windshield 104 and the sensor payload 106, and a second glare panel 114b (for example, a generally vertical panel) extending between an upper portion of the sensor payload 106 and the windshield 104. The first and second glare panels 114a, 114b may diverge from one another in a direction extending from the sensor payload 106 toward the windshield 104, generally following but not obstructing the optical cone defining the field of view 118 of the sensor payload 106 about the view axis 110. Although an optical cone may be described, other shapes are contemplated, such as a trapezoidal prism. The sensor cavity 112 is enclosed or substantially enclosed on one side by the windshield 104, thereby creating a sealed or semi-sealed optical environment between the glare shield 114 and the windshield 104.

With reference to Detail A of FIG. 1b, each of the glare panels 114a, 114b of the glare shield 114 may include a layered construction comprising a base layer 122, a heater layer 124, and an anti-glare layer 126, and may optionally include additional functional layers, such as moisture-control or optical-filtration layers, as discussed in later sections.

The base layer 122 provides mechanical strength and may be formed from a polymeric, metallic, or composite substrate. The anti-glare layer 126 can be formed from a matte-finished or absorptive material configured to reduce reflectivity and prevent stray light from entering the sensor cavity 112. Suitable materials for the anti-glare layer 126 include black anodized aluminum, dark-colored polycarbonate, or glass-fiber-reinforced composites coated with a low-gloss, light-absorptive finish. The heater layer 124 may be composed of one or more resistive heating elements or traces arranged in a defined pattern to ensure even thermal distribution.

One or more of the layers of the first and second glare panels 114a, 114b can be separate layers stacked upon one another or permanently bonded to one another (e.g., co-molded, embedded, etc.). For example, the heater layer 124 and the anti-glare layer 126 can be attached to one another and/or the base layer 122 via adhesive. In some examples, the adhesive is a peel-away adhesive that allows for the heater layer 124 and the anti-glare layer 126 to be removed from the base layer 122 for maintenance, replacement, or recyclability upon end of life. In another example, the heater layer 124 and/or the anti-glare layer 126 (or portions thereof) may be embedded in the base layer 122. For example, the traces of the heater layer 124 could be embedded in the base layer 122.

Portions of the glare shield 114, such as the base layer 122 and the anti-glare layer 126, may be manufactured using injection molding, thermoforming, or additive manufacturing techniques. The materials may include dark-colored thermoplastics such as acrylonitrile butadiene styrene (ABS), polycarbonate (PC), or blends thereof, optionally with matte or textured finishes to suppress specular reflection. Metallic coatings, conductive polymer films, or anti-static finishes may also be employed to prevent dust accumulation within the optical path.

In the illustrated example, each of the glare panels 114a, 114b of the glare shield 114 incorporates the heater layer 124 configured to provide localized heating of the sensor cavity 112. As illustrated, the first glare panel 114a directs heat into the sensor cavity 112 from one direction, represented by arrows 128b, while minimizing heat conduction toward the vehicle cabin (arrows 128e). Likewise, the second glare panel 114b directs heat into the sensor cavity 112 from another direction, as indicated by arrows 128c. The respective heating vectors of the first and second glare panels 114a, 114b are oriented transversely, creating a “dual-plane” heater arrangement that provides both direct radiant heating and secondary convective heating within the sensor cavity 112 (represented by arrows 128d). This configuration enhances heating performance by promoting even air circulation and temperature distribution within the sensor cavity 112.

The geometry of the glare shield 114 may be configured to conform to the optical field-of-view boundaries of the sensor payload 106, providing effective shading while maintaining a clear optical path. In addition to glare suppression, the glare shield 114 enhances optical and thermal stability by limiting direct solar radiation, reducing localized temperature gradients, and preventing particulate or moisture accumulation on the optical window adjacent the sensor payload 106. In certain examples, the glare shield 114 may further function as a structural support or alignment component, ensuring proper registration of the sensor payload 106 relative to the windshield 104 and minimizing internal reflections between the inner and outer glass surfaces.

The perception sensors contained within the sensor payload 106 can include, without limitation, cameras, LiDAR sensors, radar units, and ultrasonic transducers. In the illustrated example, a camera-based payload is shown. Cameras may be monocular units capturing color imagery for object and lane detection, stereo units providing depth information for three-dimensional scene reconstruction, or wide-angle cameras used for surround-view monitoring. Other examples include infrared cameras for night vision, time-of-flight sensors for depth measurement, and event-based cameras for dynamic object tracking in high-speed environments.

The sensor payload 106 can also incorporate LiDAR sensors configured to emit laser pulses to generate high-resolution three-dimensional point clouds of the environment, or radar sensors that determine the distance, velocity, and relative motion of objects via radio frequency reflections. Radar examples can include short-, medium-, and long-range variants, respectively suited for blind-spot detection, cross-traffic alerts, and adaptive cruise control functions. Ultrasonic sensors may further complement the system by providing short-range object detection for low-speed maneuvering or parking assistance.

The heater layer 124, which may take the form of a flexible film or printed heater sheet, includes a plurality of resistive traces forming a heater array. In some examples, the flexible film or printed heater sheet can be layered or laid upon the base layer 122 (e.g., on an interior surface of the sensor cavity 112). In other examples, portions of the heater layer 124 may be embedded within the base layer 122 of the glare shield 114, laminated between layers, or otherwise disposed on an inner or outer surface thereof. The traces can be fabricated from resistive materials such as etched copper, nichrome, silver ink, or conductive carbon-based pastes. In one example, the heater layer 124 is printed or laminated onto a low-loss dielectric substrate such as polyimide, polyethylene terephthalate (PET), or thin glass, selected for its transparency (where desirable), heat resistance, and dielectric strength.

The heater assembly 124 may be powered by the vehicle's electrical system, with operating voltages ranging from 12 to 48 volts depending on vehicle configuration. Integrated temperature sensors, such as thermistors or resistance temperature detectors (RTDs), may monitor the surface temperature of the glare shield 114 and provide feedback to a control module. The control module may regulate the heater power through pulse-width modulation (PWM) or proportional-integral-derivative (PID) control algorithms to maintain a desired temperature range that prevents condensation without overheating the surrounding components. In some examples, the heater assembly 124 may also be thermally segmented to independently heat localized zones within the sensor cavity 112, thereby prioritizing defogging of critical optical areas while conserving energy.

It should be appreciated that the glare shield 114 described above represents one non-limiting configuration. In other examples, the glare shield 114 may be implemented with different geometries, material compositions, or functional features, including configurations in which one or more portions of the glare shield 114 are movable, adjustable, or reconfigurable relative to the sensor payload 106 or the windshield 104. In this regard, various features of the glare shield 114 described herein (including, for example, panel orientation, layered constructions, heating elements, anti-glare treatments, and environmental control features) may be selectively combined, omitted, or modified depending on the particular application or performance requirements. Different embodiments of the glare shield 114 are not mutually exclusive, and features described in connection with one example may be incorporated into other examples where compatible. Accordingly, the system illustrated in FIGS. 1a and 1b may incorporate any combination of the glare shield configurations and features described herein or in subsequent sections.

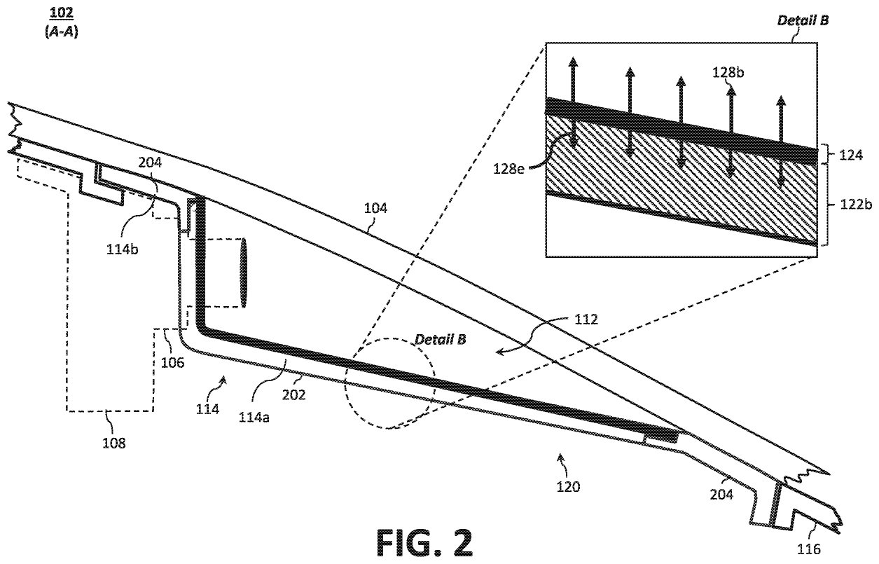

FIG. 2 illustrates an assembled cross-sectional side elevation view of a sensor system 102, in accordance with one aspect of the subject disclosure, taken along cut line A-A of FIG. 1A. In this example, the glare shield 114 is configured as a foamed glare shield 114, which may optionally be heated (e.g., via the heater layer 124). To reduce material usage and cycle time, the glare shield 114 can be formed from a foamed plastic, such as a chemically foamed plastic or a physically foamed plastic. When the glare shield 114 includes the heater layer 124 on a top side, the foamed structure provides increased thermal insulation relative to a solidly molded glare shield 114, thereby directing more heat toward the windshield 104 and increasing heating performance of the sensor system 102. In particular, the foamed structure reduces heat flux (e.g., arrows 128b) through the material due to its insulating properties, whereas solidly molded glare shields 114 typically provide less insulation and correspondingly reduced heating performance within the field of view 118. In some examples, the movable portion of the glare shield 114 may additionally or alternatively comprise a structural fleece material, such as a fleece prepreg, and/or another lightweight cellular structure. The reduced mass associated with such materials may reduce gravitational influence on the movable portion during actuation, which may be advantageous in embodiments utilizing electromagnetic actuation by reducing actuation force requirements and/or improving actuation consistency. In some embodiments, the sensor system 102 may further include a fail-safe actuation arrangement configured to bias the glare shield 114 toward a non-actuated position. Such a configuration may reduce the likelihood that the glare shield 114 remains in an actuated position that obstructs the camera and/or interferes with the field of view 118.

In some examples, the components of the sensor system 102 may be configured such that the glare shield 114 is sustainable and optionally heated (e.g., via the heater layer 124). The glare shield 114 may be formed from multiple portions, including a middle portion 202 and one or more side portions 204 (e.g., fixed portions) having different functional and structural requirements. One or more side portions 204 may define, at least partially define, or serve as the second glare panel 114b. The one or more side portions 204 can be configured as fixed components.

The middle portion 202 may include a glare-reducing (stray-light-reducing) surface (e.g., the anti-glare layer 126), which can be integrated into the middle portion 202 or provided as a separate component affixed thereto and formed from a different material. The middle portion 202 of the glare panel 114, which can generally corresponded to the above-referenced first glare panel 114a, may be characterized by lower mechanical strength, lower precision requirements, and a lower level of geometrical detail, while providing relatively high thermal insulation and thermal stability. In some examples, the middle portion 202 may be formed via injection molding using a bio-based, degradable, or recycled plastic material having comparatively lower mechanical properties. Other materials may also be used, such as injection-moldable paper.

Due to the relatively lower accuracy requirements and reduced geometric complexity, alternative manufacturing processes for the middle portion 202 may be employed, including forming or bending processes. The middle portion 202 may additionally or alternatively be configured as a sheet or panel structure, such as a bio-fiber composite sheet, a foam, a sponge, or a paper-based structure. In some examples, the sheet or panel may incorporate a honeycomb or other cellular structure providing a high air content to enhance thermal insulation.

The one or more side portions 204 may provide moderate stiffness and structural stability, while also enabling flexibility and precision for alignment and snap-fit fixation functionality. The side portions 204 may be coupled to, or integrally formed with (in some cases), the middle portion 202 using one or more joining techniques, including positive locking or positive fit connections (e.g., snap-fit, screw, rivet, or bayonet-type connections), or frictional or force-fit connections (e.g., bonding, two-component (2K) injection molding, welding, melting, or press-fit connections). In some examples, insert overmolding or a 2K injection molding process may be used to join the middle portion 202 with the side portions 204.

In certain applications, it may be desirable to enable separation of the middle portion 202 from the side portions 204 for recycling purposes. For example, the middle portion 202 may be separated from the one or more side portions 204 via breakaway features, application of heat or cold, chemical separation processes, or other techniques.

As illustrated, an additional third portion may be provided for heating and/or anti-glare functionality (e.g., the heater layer 124 or other component), which may be applied to the middle portion 202 and/or the side portions 204. Preferably, the heater layer 124 (or other functional third portion) may also be separable for recycling purposes. For example, the heater layer 124 may be mounted using a hook-and-loop fastening system (e.g., Velcro), allowing for simplified assembly and disassembly. Such a fastening system may also serve to trap air within its structure, thereby improving thermal insulation properties when the heater layer 124 is present.

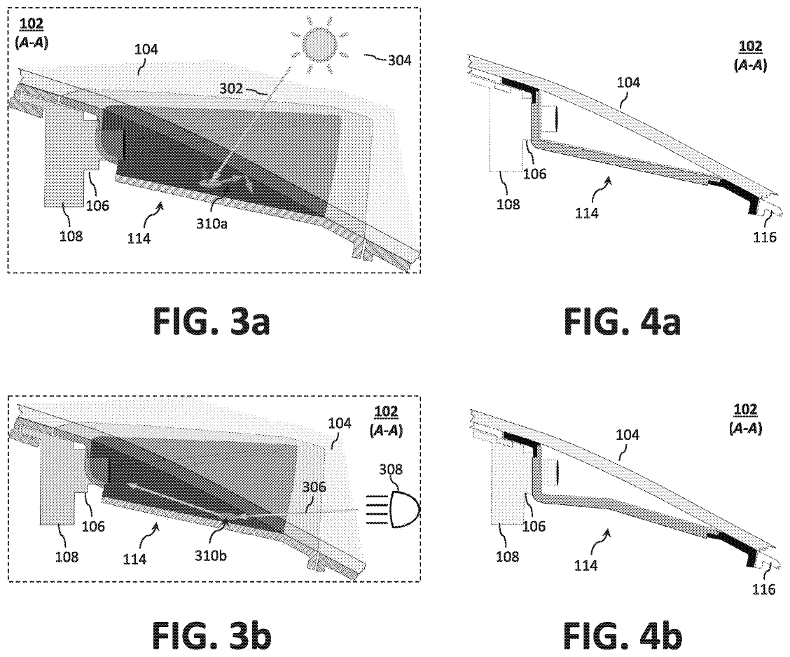

FIG. 3a illustrates an assembled cross-sectional side elevation view of a sensor system 102 taken along cut line A-A of FIG. 1A, where the glare shield 114 is configured in a first position during daytime conditions (e.g., sunlight), while FIG. 3b illustrates a similar view in which the glare shield 114 is configured in a corresponding position during nighttime conditions (e.g., exposure to oncoming headlights). The position and geometry of the glare shield 114 (e.g., particularly the middle portion 202) can influence how incident light interacts with the sensor system 102.

In particular, sunlight 302 originating from the sun 304 and projected light 306 originating from a headlight 308 may interact differently with the glare shield 114 due to differences in incident angle. With reference to FIG. 3a, sunlight 302 entering from above may be deflected and effectively scattered by the glare shield 114, as indicated by arrows 310a, thereby reducing the likelihood of interference with operation of the sensor payload 106. With reference to FIG. 3b, however, projected light 306 entering from a forward direction may be directed toward the sensor payload 106, as indicated by arrow 310b, which may adversely affect operation of the sensor payload 106.

To address these differing lighting conditions, the geometry of the glare shield 114 can be modified. FIG. 4a illustrates an example in which the glare shield 114 is configured in a first position that is effectively optimized for daytime conditions, such as by providing a generally planar structure configured to scatter light from above (e.g., sunlight 302). FIG. 4b illustrates an example in which the glare shield 114 is configured in a second position effectively optimized for nighttime conditions. In this configuration, the glare shield 114 includes two generally planar portions oriented at an angle relative to one another to scatter light entering from a forward direction (e.g., projected light 306 from a headlight 308 of an oncoming vehicle 100).

Accordingly, it may be desirable to provide a glare shield 114 that is adjustable between two or more positions (e.g., the above-described first position and the second position). A movable or otherwise adjustable glare shield 114 may be implemented in conjunction with the layered and heated constructions described above, or with alternative material selections or geometries. Such configurations may enable adjustment of the glare shield 114 to mitigate glare from various sources, including sunlight 302, and may additionally support other functions where desired, such as ventilation.

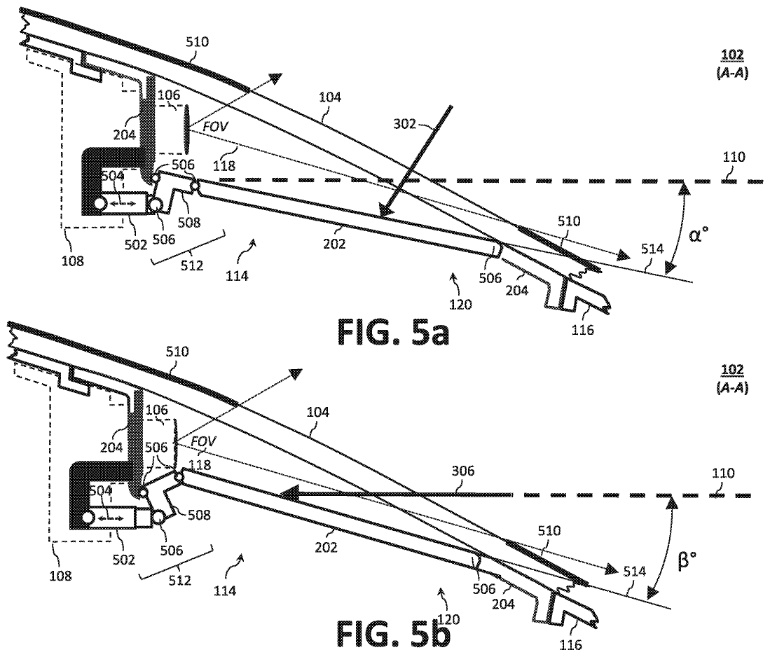

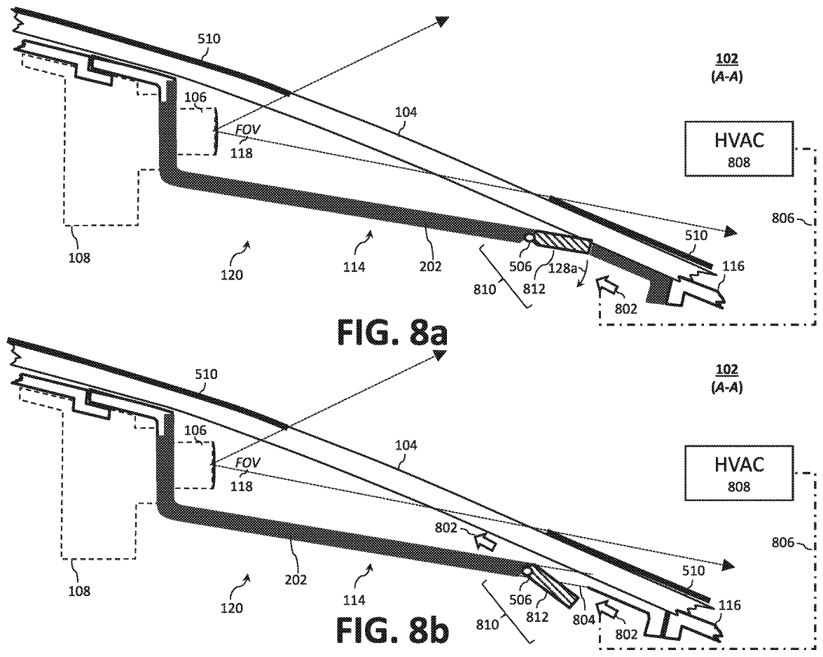

As will be described in connection with FIGS. 5a and 5b, for example, the shape and/or position of the glare shield 114 (or portions thereof) may be modified from a nominal state (a default position) to one or more alternate states (actuated positions) to achieve desired functional performance. For example, a first position may be particularly effective for mitigating glare from light sources having a significant vertical component (e.g., sunlight 302 during daytime conditions), whereas a second position may be more effective for mitigating glare from light sources having a substantially horizontal component (e.g., headlights 308 during nighttime conditions). Relatedly, as will be described in connection with FIGS. 8a and 8b, for example, the geometry of the glare shield 114 (or portions thereof) may also be modified to control ventilation within the field of view 118. For example, when a heater is applied to the field of view, the windshield 104, or the glare shield 114, a movable portion of the glare shield 114 may function as a valve to regulate airflow into and out of the sensor cavity 112. In a first position (e.g., a sealed or substantially sealed position), ventilation may be minimized to enable rapid heating, such as during defrosting. In other positions (e.g., a vented position), increased ventilation may be provided to sensor cavity 112 to reduce condensation by facilitating exchange of humid air with drier ambient air.

Movement or reconfiguration of the glare shield 114 may be achieved through various actuation mechanisms. In some examples, an actuator powered by a DC motor or a brushless DC (BLDC) motor may be used. In other examples, a shape memory alloy (SMA) actuator 502 may be employed, optionally in combination with a mechanical spring, such as a flat spring 904 (e.g., a cantilever or simple beam spring, leaf spring) or a helical spring (e.g., a torsion spring 1002 or a compression spring).

In other examples, actuation may be achieved using an electromagnet in combination with a permanent magnet and a mechanical spring (or a permanent magnet). Such arrangements may enable rapid movement and simplified control using relatively few components. As with SMA-based systems, one direction of movement may be driven by the electromagnet, while the return movement may be provided by the spring, allowing the system to default to a nominal configuration in the absence of power.

In further examples, the glare shield 114 may be actuated using mechanical input or thermal energy derived from other vehicle systems. For instance, a Bowden cable or other mechanical linkage may be coupled to the glare shield 114 to provide actuation from a remotely located actuator. Additionally, or alternatively, waste heat or dissipated energy from other vehicle systems may be used to actuate components, such as by heating an SMA actuator 502 or a bimetal actuator 702.

FIGS. 5a and 5b illustrate assembled cross-sectional side elevation views of a sensor system 102 having a glare shield 114 configured with a movable portion to alternate between a first position and a second position in accordance with one aspect of the subject disclosure. In this example, the glare shield 114 includes a middle portion 202 that is movable relative to one or more fixed side portions 204. The middle portion 202 is configured to move between the first position and the second position to modify the optical characteristics of the sensor cavity 112. The first end of the middle portion 202 is pivotally connected to one of the side portions 204 via a pivot connection 506, which may include, for example, a pin, hinge, or other rotational coupling. A second end of the middle portion 202, opposite the first end, is pivotally connected to the other side portion 204 via an actuator assembly 512.

In the illustrated example, the windshield 104 includes a coating of material 510 disposed around at least a perimeter of the field of view 118. The coating of material 510 is configured to inhibit or prevent transmission of light through portions of the windshield 104 outside the intended optical region. The coating of material 510 may comprise, for example, a black paint, a laminate, or another suitable coating material applied to the windshield 104.

The actuator assembly 512 generally comprises a mechanical linkage 508, a plurality of pivot connections 506, and a shape memory alloy (SMA) actuator 502. The mechanical linkage 508 is operatively coupled between the side portion 204, the middle portion 202, and the SMA actuator 502, such that movement of the SMA actuator 502 causes corresponding movement of the middle portion 202. In the illustrated example, the mechanical linkage 508 is configured as an L-shaped link (e.g., a substantially 90-degree linkage component), with each end of the linkage being pivotally connected via a respective pivot connection 506 to the side portion 204, the middle portion 202, and the SMA actuator 502.

The illustrated SMA actuator 502 is coupled to the side portion 204 and is configured to actuate the mechanical linkage 508 relative to the side portion 204, thereby moving or otherwise adjusting the position of the middle portion 202. The SMA actuator 502 may include one or more elements that contract and expand in response to temperature changes, thereby generating motion, as indicated by arrow 504. SMA actuators 502 may provide advantages including compact size, high power density, low acoustic noise, minimal electromagnetic interference, and relatively simple control. In some configurations, movement in a first direction may be driven by contraction of the SMA actuator 502, while return movement may be provided by a mechanical spring, thereby enabling the system to return to a nominal state in the event of power loss.

With reference to FIG. 5a, when the SMA actuator 502 is in a contracted position, the mechanical linkage 508 is pivoted such that the middle portion 202 is positioned to place the glare shield 114 in the first position. In this configuration, the glare shield 114 is arranged to scatter light entering from above, such as sunlight 302, thereby reducing the impact of such light on the sensor payload 106.

With reference to FIG. 5b, when the SMA actuator 502 is in an extended position, the mechanical linkage 508 is pivoted in an opposite direction such that the middle portion 202 is repositioned to place the glare shield 114 in the second position. In this configuration, the glare shield 114 is arranged to scatter light entering from a forward direction, such as projected light 306 from a headlight 308 of an oncoming vehicle 100. As illustrated, a first angle (α) defined between a plane 514 of the middle portion 202 and the view axis 110 in the first position (e.g., for daytime use) is less than a second angle (β) defined between the plane 514 and the view axis 110 in the second position (e.g., for nighttime use). This variation in angular orientation enables the glare shield 114 to selectively adapt its light-scattering characteristics based on operating conditions.

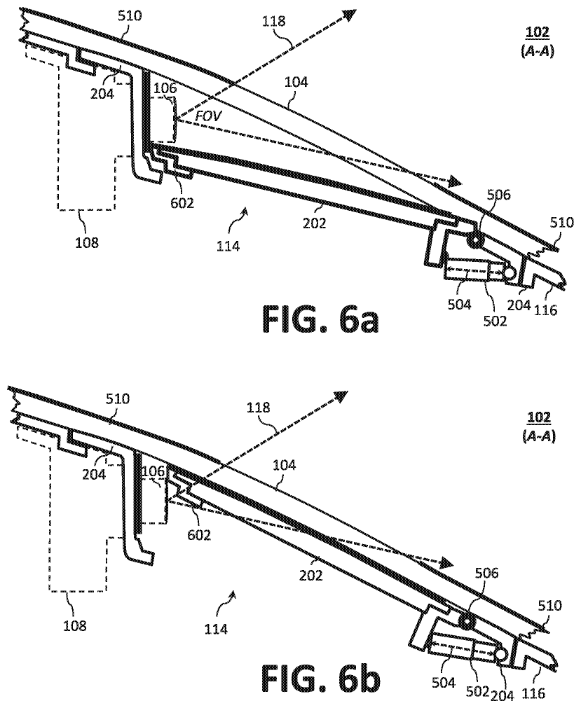

FIGS. 6a and 6b illustrate assembled cross-sectional side elevation views of a sensor system 102 having a movable glare shield 114 configured to alternate between a first position and a second position in accordance with another aspect of the subject disclosure. The movable glare shield 114 in this example may share certain features with the configuration described in connection with FIGS. 5a and 5b; however, this configuration differs in structure and operation to improve defrosting performance. For brevity, the description for FIGS. 6a and 6b does not reiterate previously-described features, rather, it instead emphasizes distinctions.

In this example, the glare shield 114 again includes a middle portion 202 that is movable relative to one or more side portions 204 (e.g., the second glare panel 114b). Unlike the configuration of FIGS. 5a and 5b, the middle portion 202 is pivotally connected at only one end. This pivotal connection is provided via a pivot connection 506 in combination with an associated SMA actuator 502, which together enable controlled movement of the middle portion 202. The opposite end of the middle portion 202 is not directly constrained by a second pivot and is therefore free to move relative to the surrounding structure.

The free end of the middle portion 202 includes an end stop 602. The end stop 602 is configured to selectively abut different components depending on the position of the glare shield 114. In one position, the end stop 602 is arranged to contact or abut a corresponding part of a side portion 204, thereby defining a first limit position of the glare shield 114. In another position, the end stop 602 is arranged to move upwardly to contact or abut the windshield 104, thereby defining a second limit position. This arrangement provides a controlled range of motion for the middle portion 202 while enabling direct interaction with the windshield 104 in at least one operational state.

The configuration illustrated in FIGS. 6a and 6b is particularly well suited for configurations in which the glare shield 114 includes the heater layer 124. When a heater layer 124 is positioned on a top portion (e.g., surface) of the glare shield 114, movement of the middle portion 202 can be used to selectively modify the thermal coupling between the heater layer 124 and the windshield 104.

In a first, nominal position, the glare shield 114 may be oriented to provide a geometry for glare mitigation and sensor visibility, consistent with the optical requirements of the sensor payload 106. In this position, the heater layer 124 may primarily function to prevent or remove condensation within the sensor cavity 112, for example by heating air within the cavity and promoting evaporation or reducing relative humidity.

In a second position, the glare shield 114 may be repositioned, via actuation of the SMA actuator 502 to pivot the moveable portion about the pivot connection 506, such that the heater layer 124 is brought into proximate or direct contact with the windshield 104. In this configuration, the heater layer 124 effectively functions as a windshield heater, transferring heat directly to the windshield 104 through conductive contact. By eliminating (or substantially reducing) any intervening air gap between the heater layer 124 and the windshield 104, the efficiency of heat transfer is increased, thereby improving defrosting performance.

This contact-based heating configuration may be particularly advantageous under conditions in which the windshield 104 is obstructed by ice, frost, or snow. Although repositioning the glare shield 114 into the second position may temporarily compromise the optical path of the sensor payload 106, such compromise may be acceptable under conditions where the field of view 118 is already sufficiently impaired by environmental buildup. Once the obstruction is removed and the windshield 104 is sufficiently cleared, the glare shield 114 may be returned to the nominal position. Further, the use of a single pivot connection 506 in combination with the end stop 602 provides a simplified mechanical arrangement that facilitates reliable movement between the two positions while ensuring consistent positioning at each end of travel.

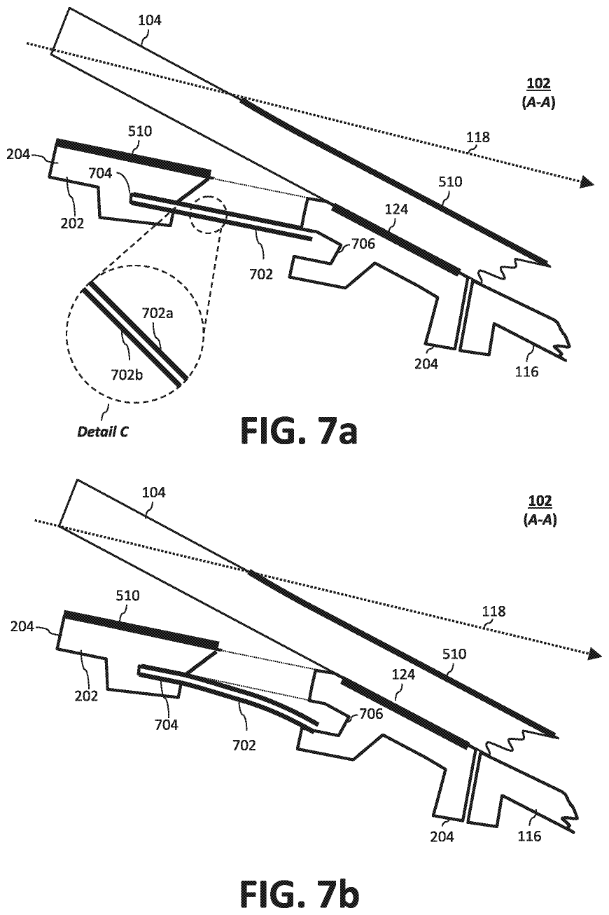

FIGS. 7a and 7b illustrate assembled cross-sectional side elevation views of a sensor system 102 with a movable glare shield 114 that is configured to alternate between the first position and the second position in accordance with another aspect of the subject disclosure.

In the configuration of FIGS. 7a and 7b, the sensor system 102 applies a movable glare shield 114 in a manner generally consistent with previously described examples but introduces a different actuation approach using a bimetal actuator 702. While certain structural aspects of the sensor system 102 correspond to those discussed with respect to earlier figures, this configuration uses the bimetal actuator 702 in place of, or in addition to, other actuation mechanisms (such as the SMA actuator 502), thereby providing a thermally responsive and passive mode of operation.

Like that of FIGS. 6a and 6b, the middle portion 202 of the glare shield 114 remains pivotally connected at only one end to the side portion 204, for example at a location adjacent the sensor payload 106 (here, the second glare panel 114b), such that the middle portion 202 is capable of pivoting movement about a pivot connection 506 (not shown in FIGS. 7a and 7b). The opposite end of the middle portion 202 is formed to include a slot 704 that is configured to receive and retain a first end or edge of the bimetal actuator 702. The slot 704 is dimensioned to secure the bimetal actuator 702 while permitting relative motion sufficient to accommodate deformation of the bimetal actuator 702 during operation. The second, opposite end or edge of the bimetal actuator 702 is disposed within an actuator cavity 706. The actuator cavity 706, together with the windshield 104, provides a defined space that allows the bimetal actuator 702 to move through a limited range of motion as it changes shape.

The bimetal actuator 702 includes or employs a bimetal element formed by bonding together two dissimilar metals, identified as metal layers 702a and 702b in Detail C, each having a different coefficient of thermal expansion. As temperature varies, the differential expansion or contraction of these metal layers 702a and 702b induces bending or curving of the bonded structure of the bimetal actuator 702 in a controlled and repeatable manner. The specific direction of curvature is determined by the relative coefficients of thermal expansion of the metal layers 702a and 702b, such that the actuator tends to curve toward the layer having the lower coefficient of thermal expansion when subjected to increased temperature. The magnitude and responsiveness of this deformation may be tuned through appropriate selection of materials, adjustment of layer thicknesses, and overall structural configuration of the bimetal actuator 702.

At lower temperatures, the bimetal actuator 702 assumes a first configuration, which in many implementations is substantially planar or only minimally curved. As the temperature rises, the bimetal actuator 702 transitions to a second configuration illustrated with a pronounced curvature. This thermally induced deformation is reversible, such that upon cooling, the bimetal actuator 702 returns toward its original, lower-temperature shape (or vice versa). This reversible behavior enables repeated cycling between configurations without reliance on external electrical power, dedicated control circuitry, or active feedback mechanisms.

The bimetal actuator 702 may be implemented in a variety of geometries depending on design requirements, including elongated strips, planar plates, or disk-shaped elements. Strip and plate configurations may be selected where directional bending is desired to produce a controlled rotational movement of the middle portion 202. In contrast, disk-shaped configurations may be employed in applications where snap-through behavior between stable states at defined temperature thresholds is advantageous. Examples of each are provided herein. The geometry and mounting arrangement within the slot 704 and actuator cavity 706 can be tailored to achieve specified displacement ranges, actuation forces, and temperature response characteristics suitable for the intended operating environment of the sensor system 102.

When integrated within the sensor system 102, the bimetal actuator 702 operates in conjunction with the glare shield 114 to provide temperature-responsive adjustment of the shield position. In particular, the actuator may be coupled between the free end of the middle portion 202 and a fixed or constrained region within the actuator cavity 706 such that deformation of the actuator directly induces rotational movement of the middle portion 202 about its pivotal connection to the side portion 204.

As temperature within the sensor cavity 112 increases, for example due to operation of the heater layer 124 (or the later described secondary heater) or exposure to elevated ambient conditions, the resulting curvature of the bimetal actuator 702 urges the middle portion 202 toward a position that reconfigures the glare shield 114 to adjust the angle of the middle portion 202 (and/or to create or enlarge a ventilation airflow port 804, examples of which will be described starting at FIGS. 8a and 8b). This opening facilitates airflow through the sensor cavity 112, thereby facilitating heat dissipation and assisting in moisture management.

Conversely, when the temperature decreases, the bimetal actuator 702 relaxes toward its original (nominal) shape, allowing the middle portion 202 to return toward a position corresponding to a more closed configuration of the glare shield 114. In this condition, airflow through the sensor cavity 112 is reduced, and the glare shield 114 provides enhanced suppression of stray light or glare that could otherwise affect the performance of the sensor payload 106. The passive nature of this thermally driven actuation enables the system to dynamically balance ventilation (where desired) and optical shielding.

As shown in FIG. 7a, when the bimetal actuator 702 is at a first temperature, it is generally planar, and the orientation of the middle portion 202 positions the glare shield 114 in the first position, which may correspond to a configuration suitable for daytime operation with reduced ventilation and increased glare blocking. In contrast, as illustrated in FIG. 7b, when the bimetal actuator 702 is at a second, higher temperature, it assumes a curved shape that reorients the middle portion 202 such that the glare shield 114 assumes the second position. This second position may correspond to a configuration suitable for nighttime or high-temperature conditions, in which increased ventilation is provided to the sensor cavity 112 while still maintaining an appropriate level of optical shielding.

FIGS. 8a and 8b illustrate assembled cross-sectional side elevation views of a sensor system 102 with a movable glare shield 114 that is configured to alternate between, respectively, a sealed position and a vented position in accordance with one aspect of the subject disclosure.

As illustrated, the sensor system 102 includes a movable glare shield 114 that is movable between a sealed position and a vented position, thereby controlling airflow within the sensor cavity 112.

The movable glare shield 114 in this example includes a ventilation assembly 810 disposed at or near an end of the middle portion 202. The ventilation assembly 810 is configured to selectively permit or restrict airflow 802 through one or more airflow ports 804 formed in or associated with the sensor cavity 112. These airflow ports 804 provide fluid communication between the interior of the sensor cavity 112 and an external air source, such that airflow 802 may be introduced into, circulated within, or exhausted from the sensor cavity 112 depending on the operational state of the glare shield 114 and the ventilation assembly 810.

The ventilation assembly 810 includes a movable body 812 that is operatively coupled to the middle portion 202 via a pivot connection 506. The pivot connection 506 enables the movable body 812 to rotate relative to the middle portion 202, as indicated by arrow 128a, between positions that respectively open and close the associated airflow port 804. Thus, the movable body 812 functions as a controllable valve element that regulates the passage of airflow 802 through the airflow port 804. The movable body 812 may be implemented as, or incorporate, a bimetal actuator 702, thereby allowing the position of the movable body 812 to be responsive to temperature changes. In other implementations, the movable body 812 may be driven or positioned by an alternative actuator, including but not limited to electromechanical, thermal, or SMA-based actuators.

When the glare shield 114 is in the first position, as illustrated in FIG. 8a, the movable body 812 is oriented to close or substantially close the airflow port 804, thereby placing the sensor cavity 112 in a sealed or substantially sealed condition. In this state, ventilation is minimized, which may be advantageous for promoting rapid heating within the sensor cavity 112, such as during defrosting or deicing operations. By limiting airflow exchange with the surrounding environment, heat generated within the sensor cavity 112, for example by the heater assembly 124, may be retained more effectively, allowing the system to reach desired operating temperatures more quickly.

Conversely, when the glare shield 114 is in the second position, as illustrated in FIG. 8b, the movable body 812 is repositioned to open the airflow port 804, thereby establishing a vented condition. In this configuration, increased ventilation is enabled, allowing airflow 802 to pass into and through the sensor cavity 112. This airflow may enter through one airflow port 804, move across internal surfaces such as the interior surface of the windshield 104, and exit through the same airflow port 804 or through a different airflow port 804. In some implementations, separate airflow ports 804 may be designated for inflow and outflow, thereby establishing a more defined flow path through the sensor cavity 112.

The airflow 802 used for conditioning the sensor cavity 112 may be sourced from multiple origins. In addition to, or as an alternative to, relying solely on heat generated by the heater assembly 124, airflow 802 may be supplied from a supply vent 806 that is fluidically coupled to an HVAC unit 808. The HVAC unit 808 may provide conditioned air, including heated, cooled, dehumidified, or otherwise treated air, to the sensor cavity 112 to achieve desired environmental conditions. The supply vent 806 may be integrated into the vehicle structure in a manner that directs airflow 802 toward the airflow port 804 and into the sensor cavity 112.

In some configurations, the airflow port 804 may be directly open to ambient air within the vehicle cabin, either independently or via the supply vent 806, such that cabin air can be drawn into or expelled from the sensor cavity 112. The HVAC unit 808 providing such airflow may be part of the primary vehicle climate control system or may be a dedicated, localized HVAC component specifically configured to service the sensor system 102.

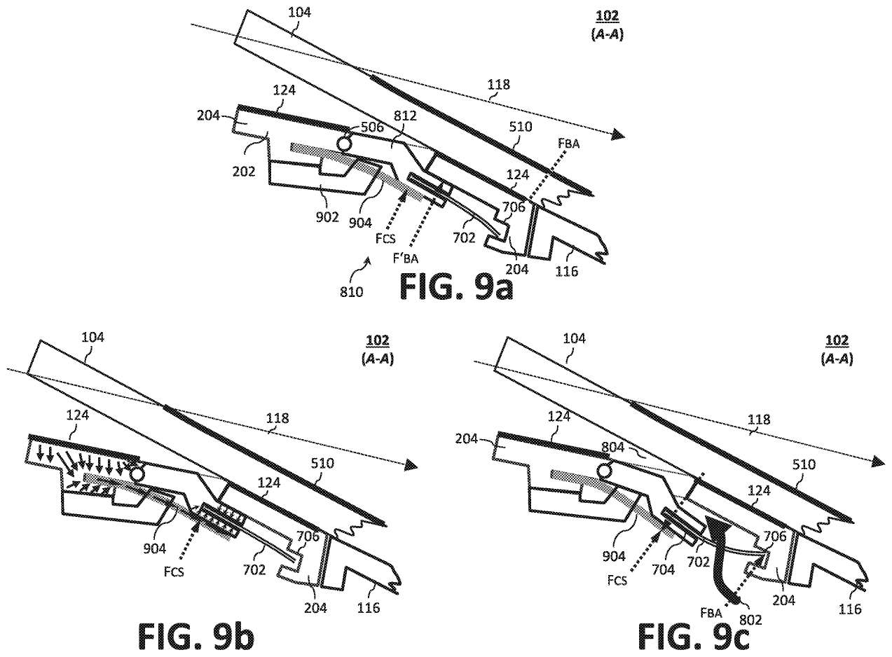

FIGS. 9a through 9c illustrate assembled cross-sectional side elevation views of a sensor system 102 with a movable glare shield 114 that is configured to alternate between the sealed position and the vented position in accordance with one aspect of the subject disclosure.

In the configuration shown in FIGS. 9a through 9c, the ventilation assembly 810 includes the movable body 812, the bimetal actuator 702, and a flat spring 904 that functions as a closing spring. The movable body 812 of the glare shield 114 is arranged to selectively open and close the airflow port 804, consistent with previously described examples, while the bimetal actuator 702 provides temperature-dependent actuation. The flat spring 904 is positioned and configured to apply a biasing force that urges the movable body 812 toward a closed position, thereby establishing a default state in which the airflow port 804 is sealed or substantially sealed in the absence of sufficient force from the bimetal actuator 702.

A valve stop 902 is also provided as part of the ventilation assembly 810 to control or limit the movement of the movable body 812 and associated components. The valve stop 902 may be configured to physically constrain the range of motion of the movable body 812 itself, and in certain examples may additionally or alternatively constrain movement of the bimetal actuator 702 and/or the flat spring 904.

FIG. 9a illustrates a condition of the sensor system 102 when the heater assembly 124 is off, such that the temperature within the sensor cavity 112 is relatively low. Under these conditions, the bimetal actuator 702 exerts a force that may be represented as F′BA, while the flat spring 904 exerts a closing force FCS. The combined or resulting force, expressed as FCS+F′BA, acts in a direction that causes the movable body 812 to close the airflow port 804. Accordingly, in this state, the ventilation assembly 810 maintains the sensor cavity 112 in a sealed or substantially sealed condition.

FIG. 9b illustrates an intermediate condition in which the heater assembly 124 is actively heating, and the temperature within the sensor cavity 112 is increasing but has not yet reached a nominal or steady-state level. In this transitional state, the forces acting on the movable body 812 are such that the closing force FCS provided by the flat spring 904 remains dominant or substantially balanced against the force generated by the bimetal actuator 702.

FIG. 9c illustrates the condition in which the heater assembly 124 has reached its nominal heating temperature (e.g., a target temperature or temperature range), resulting in a corresponding increase in temperature within the sensor cavity 112. At this elevated temperature, the bimetal actuator 702 undergoes sufficient deformation to generate an increased actuation force, denoted as F′BA, which exceeds the closing force FCS provided by the flat spring 904. Under these conditions, the relationship F′BA>FCS results in a net opening force acting on the movable body 812, causing the movable body 812 to pivot into an open position relative to the airflow port 804. This transition establishes the vented position of the ventilation assembly 810, allowing airflow 802 to pass through the airflow port 804 and into or out of the sensor cavity 112.

At lower temperatures and during initial heating, the flat spring 904 ensures that the movable body 812 remains closed to facilitate heat retention. As temperature increases to a threshold determined by the characteristics of the bimetal actuator 702 and the spring constant of the flat spring 904, the balance of forces shifts to open the movable body 812, thereby enabling ventilation.

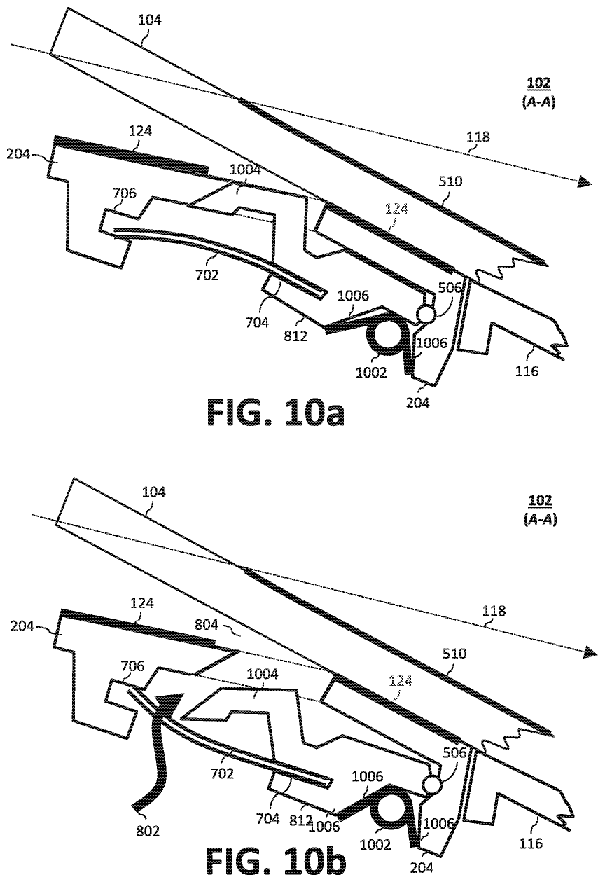

FIGS. 10a and 10b illustrate assembled cross-sectional side elevation views of a sensor system 102 with a movable glare shield 114 that is configured to alternate between the sealed position and the vented position in accordance with another aspect of the subject disclosure. In this arrangement, the operational state of the ventilation assembly is again responsive to the thermal condition within the sensor cavity 112, as influenced by the heater assembly 124. FIG. 10a depicts the condition in which the heater assembly 124 is off, while FIG. 10b depicts the condition in which the heater assembly 124 has reached a nominal operating temperature.

In the configuration of FIGS. 10a and 10b, the ventilation assembly includes the movable body 812, a torsion spring 1002, and a bimetal actuator 702 that cooperatively controls the opening and closing of the airflow port 804. The torsion spring 1002 is arranged to maintain the movable body 812 in a closed position under lower-temperature conditions. More specifically, the torsion spring 1002 is positioned between portions of the side portion 204 and is configured to abut respective spring surfaces 1006 defined by both the movable body 812 and the side portion 204. The torsion spring 1002 applies a rotational biasing force to the movable body 812 about the pivot connection 506, thereby urging the movable body 812 toward a position in which the airflow port 804 is closed.

The movable body 812 further includes a plug portion 1004 (which can be integrally formed) that is shaped and dimensioned to fill and sufficiently obstruct the airflow port 804 when the movable body 812 is in the closed position. This plug portion 1004 enhances the sealing function of the movable body 812 by reducing or preventing airflow through the airflow port 804 when the ventilation assembly is in the sealed state. The movable body 812 is coupled at one end to the side portion 204 via the pivot connection 506, enabling rotational movement, and is coupled at an opposite end to another portion of the side portion 204 through the bimetal actuator 702.

The bimetal actuator 702 in this configuration is coupled to the movable body 812 via the slot 704 and is further coupled to the side portion 204 via the actuator cavity 706. This mounting arrangement allows the bimetal actuator 702, which may be configured as a strip or plate, to deform in response to temperature changes and thereby exert a force on the movable body 812. At lower temperatures, as shown in FIG. 10a, the torsion spring 1002 dominates, maintaining the movable body 812 in the closed position with the plug portion 1004 obstructing the airflow port 804. As the temperature increases and the heater assembly 124 reaches nominal operating conditions, as shown in FIG. 10b, the bimetal actuator 702 deforms sufficiently to counteract the bias of the torsion spring 1002 and rotate the movable body 812 toward an open position, thereby transitioning the ventilation assembly to the vented state and allowing airflow 802 through the airflow port 804.

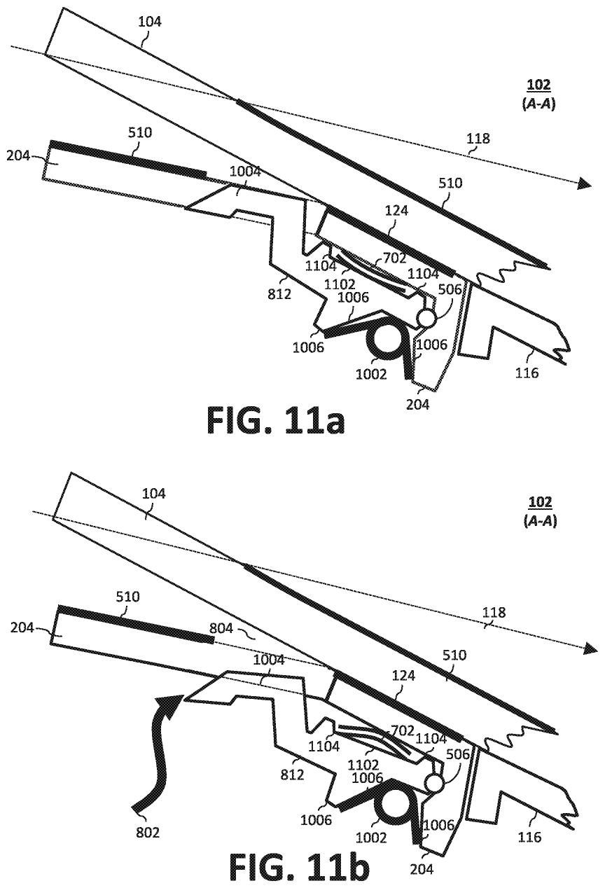

FIGS. 11a and 11b illustrate assembled cross-sectional side elevation views of a sensor system 102 with a movable glare shield 114 that is configured to alternate between the sealed position and the vented position in accordance with yet another aspect of the subject disclosure. The sensor system 102 that is generally similar in overall function to the configuration of FIGS. 10a and 10b, but differs in the form and placement of the bimetal actuator 702. In this embodiment, the bimetal actuator 702 is positioned between the movable body 812 and a portion of the side portion 204 in a manner that produces a pushing action rather than the bending action associated with a strip-format actuator. In particular, the bimetal actuator 702 may be configured as a disc-shaped element that exhibits out-of-plane deformation, thereby pushing the movable body 812 toward or away from the windshield 104 as it changes shape in response to temperature.

FIG. 11a illustrates a condition in which the heater assembly 124 is off and the temperature within the sensor cavity 112 is relatively low. Under these conditions, the bimetal actuator 702 remains in a configuration that does not significantly displace the movable body 812, allowing any associated biasing element, such as a spring, to maintain the movable body 812 in a closed position over the airflow port 804. FIG. 11b illustrates the condition in which the heater assembly 124 has reached its nominal temperature, causing the bimetal actuator 702 to deform into a configuration that exerts a force on the movable body 812 sufficient to move it away from the airflow port 804. This movement transitions the ventilation assembly into the vented position, thereby permitting airflow 802 through the sensor cavity 112.

The bimetal actuator 702 in this configuration is positioned within a recess 1102 formed in the movable body 812. The recess 1102 is defined by opposing recess sidewalls 1104 that serve to constrain and retain the bimetal actuator 702 relative to the movable body 812. This recessed mounting arrangement ensures that the actuator remains properly aligned and engaged with the movable body 812 during thermal cycling, while also providing a controlled environment for the actuator's movement. The interaction between the bimetal actuator 702 and the surrounding structure enables the actuator to apply a force normal to the surface of the movable body 812, thereby moving the movable body 812 toward or away from the airflow port 804.

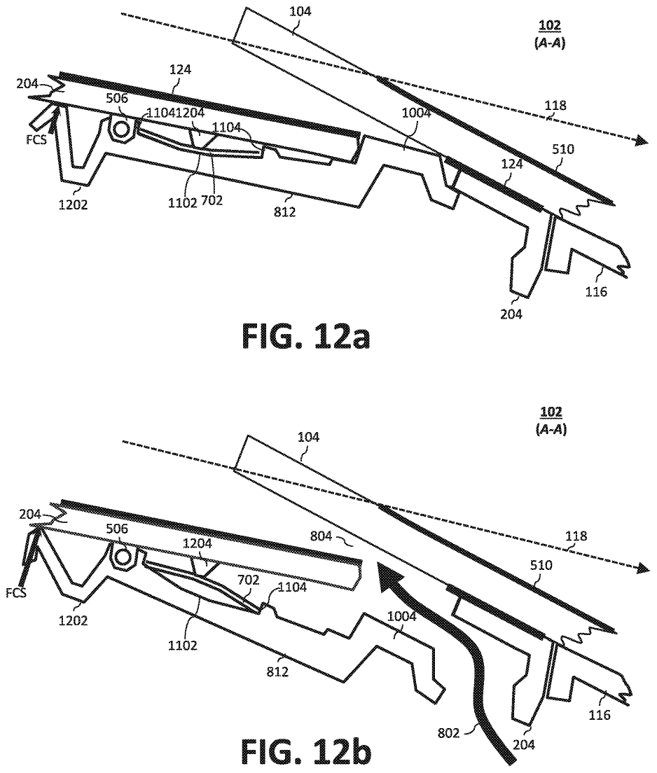

FIGS. 12a and 12b illustrate additional assembled cross-sectional side elevation views of the sensor system 102 in which the movable glare shield 114 is configured to alternate between the sealed position and the vented position in accordance with a further aspect of the subject disclosure. As with previously described examples, the operational state of the ventilation assembly is influenced by the thermal condition within the sensor cavity 112, particularly as affected by operation of the heater assembly 124. FIG. 12a illustrates a configuration when the heater assembly 124 is off, while FIG. 12b illustrates a configuration when the heater assembly 124 has reached a nominal operating temperature.

The configuration shown in FIGS. 12a and 12b is generally similar to that described with respect to FIGS. 11a and 11b, including the use of a bimetal actuator 702 that is arranged to move the movable body 812 toward and away from the airflow port 804 in response to temperature changes. In this example, the location of the pivot connection 506 is shifted to the opposite side portion 204 relative to the earlier configuration.

In addition, the torsion spring 1002 used in prior examples is omitted in this configuration, and its biasing function is instead provided by a retention spring portion 1202 that is integrated directly into the material of the movable body 812. The retention spring portion 1202 may be formed as an integral feature of the movable body 812, for example as a molded plastic element having inherent elasticity. In certain implementations, the movable body 812, including the retention spring portion 1202, may be formed from a low-creep plastic material, such as polyoxymethylene (POM), to ensure that the spring characteristics are maintained over time and under repeated thermal cycling. The retention spring portion 1202 serves to provide a restoring force that biases the movable body 812 toward the closed position when the bimetal actuator 702 is not exerting sufficient force to open the airflow port 804.

A stand-off 1204 is further defined on a surface of the side portion 204 and is configured to engage the bimetal actuator 702, for example at or near a central region of a disc-shaped actuator. The stand-off 1204 serves to assist in spacing and supporting the movable body 812 when heat is applied and the bimetal actuator 702 deforms. The stand-off 1204 can improve the transfer of force to the movable body 812.

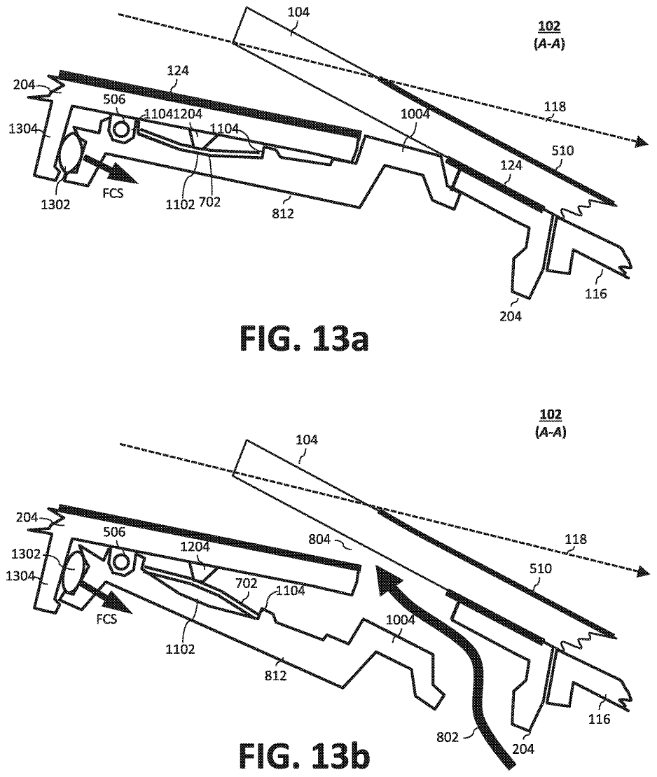

FIGS. 13a and 13b illustrate another example of the sensor system 102 that is substantially similar to the configuration of FIGS. 12a and 12b, with the primary distinction being the manner in which the closing or retention force on the movable body 812 is generated. FIG. 13a shows the system with the heater assembly 124 off, while FIG. 13b shows the system at nominal heating temperature. In this example, the retention spring portion 1202 is omitted, and its function is replaced by a compressive ball 1302.

The compressive ball 1302 is positioned between a surface at an end of the movable body 812, adjacent the pivot connection 506, and an abutment surface 1304 defined by the side portion 204. The compressive ball 1302 may be formed as a soft component that exhibits a spring-like effect while minimizing or eliminating relaxation over time.

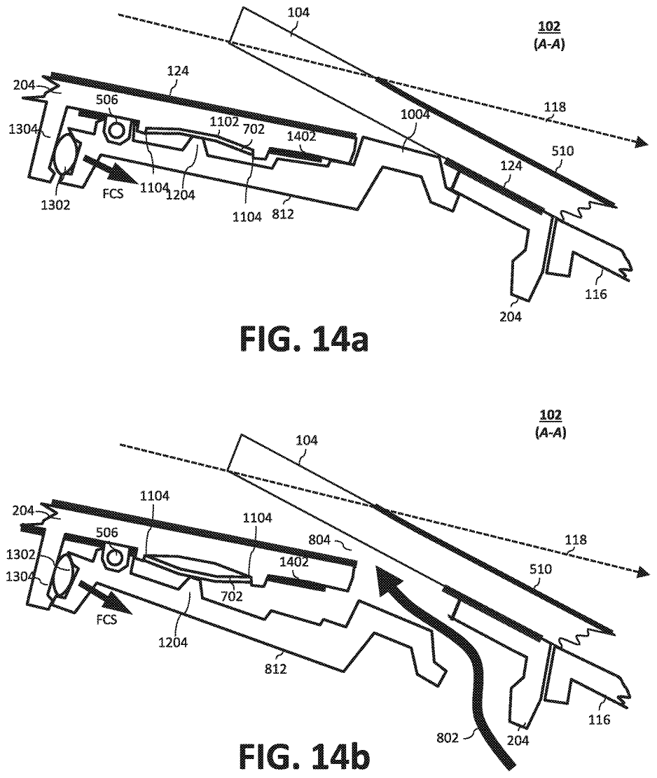

FIGS. 14a and 14b illustrate a further variation of the sensor system 102 that is substantially similar to the configuration of FIGS. 13a and 13b, but with the addition of a second heater assembly 1402. FIG. 14a shows the system with the heater assembly 124 off, while FIG. 14b shows the system at nominal temperature. The second heater assembly 1402 is positioned in association with the glare shield 114, for example below the glare shield 114, and may be implemented using the same printing techniques as the primary heater assembly 124, potentially utilizing a return flange of a tail area for integration.

The second heater assembly 1402 is configured to provide localized heating that specifically influences the operation of the movable body 812 and the associated bimetal actuator 702. By selectively energizing the second heater assembly 1402, the system can control the opening of the ventilation assembly independently from the primary heater assembly 124 that conditions the sensor cavity 112. This independent control allows for more precise management of airflow 802 through the airflow port 804, enabling the system to open or close the movable body 812 based on factors other than general cavity temperature.

For example, the vehicle 100 may determine when to open the ventilation assembly based on environmental or operational data, such as climatic conditions, humidity levels, or sensor performance metrics. In some implementations, this determination may be informed by camera-based machine learning algorithms that evaluate conditions at or near the windshield 104 and identify optimal ventilation strategies. The second heater assembly 1402 can then be activated to induce deformation of the bimetal actuator 702, thereby opening the movable body 812 at appropriate times even if the primary heater assembly 124 is not at a temperature that would otherwise trigger such movement. This arrangement provides an additional degree of control and adaptability in managing the internal environment of the sensor system 102.

While the present method and/or system has been described with reference to certain examples, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular examples disclosed. Instead, the present method and/or system will include all examples falling within the scope of the appended claims, both literally and under the doctrine of equivalents.

What is claimed is:

1. A housing assembly for a sensor payload configured to detect an environment through a windshield of a vehicle, the housing assembly comprising:
a glare shield configured to define a sensor cavity adjacent the windshield,
wherein the glare shield comprises a movable portion configured to move between at least a first position and a second position,
wherein the movable portion is coupled to an actuator configured to move the movable portion between the first position and the second position, and
wherein, based on the position of the movable portion, the movable portion is configured to modify at least one of:
(i) light propagation through the windshield into the sensor cavity, or
(ii) airflow within the sensor cavity through the glare shield.

2. The housing assembly of claim 1, wherein the first position is configured to reduce glare from light entering from above, and the second position is configured to reduce glare from light entering from a forward direction.

3. The housing assembly of claim 1, wherein the movable portion is pivotally mounted to at least one side portion of the glare shield.

4. The housing assembly of claim 1, wherein the movable portion is actuated by a mechanical linkage coupled to the actuator.

5. The housing assembly of claim 1, wherein the actuator comprises a shape memory alloy (SMA) actuator.

6. The housing assembly of claim 1, wherein the actuator comprises a bimetal actuator configured to deform in response to temperature.

7. The housing assembly of claim 1, further comprising a spring configured to bias the movable portion toward one of the first position or the second position.

8. The housing assembly of claim 7, wherein the spring comprises at least one of a flat spring, a torsion spring, or a compression element.

9. The housing assembly of claim 1, wherein the movable portion includes an end stop configured to define at least one limit position.

10. The housing assembly of claim 1, wherein the movable portion is configured to contact the windshield in one of the positions.

11. The housing assembly of claim 1, wherein the glare shield includes a heater layer configured to heat the sensor cavity.

12. The housing assembly of claim 1, further comprising a ventilation assembly including an airflow port and a valve element coupled to the movable portion.

13. The housing assembly of claim 12, wherein the valve element is configured to selectively open and close the airflow port based on the position of the movable portion.

14. The housing assembly of claim 12, wherein the actuator is a thermally-responsive actuator.

15. The housing assembly of claim 1, further comprising a secondary heater configured to control movement of the movable portion independently of a primary heater.

16. A system for sensing an environment through a windshield of a vehicle, the system comprising:
a sensor payload configured to detect an environment through a windshield of the vehicle; and
a housing assembly configured to define a sensor cavity adjacent the windshield, the housing assembly comprising a glare shield and an actuator,
wherein the glare shield comprises a movable portion coupled to the actuator and configured to move between at least a first position and a second position, and
wherein, based on the position of the movable portion, the movable portion is configured to modify at least one of:
(i) light propagation through the windshield into the sensor cavity, or
(ii) airflow within the sensor cavity through the glare shield.

17. The system of claim 16, wherein the movable portion is actuated by a mechanical linkage coupled to the actuator.

18. The system of claim 16, wherein the actuator comprises a shape memory alloy (SMA) actuator.

19. The system of claim 16, wherein the actuator comprises a bimetal actuator configured to deform in response to temperature.

20. The system of claim 16, wherein the actuator is a thermally-responsive actuator.
